(19) United States
(12) Patent Application Publication
(10) Pub. No.: US 2003/0154445 A1
(43) Pub. Date: Aug. 14, 2003

(54) Module for generating objects, from raw data retrieved from at least a data source containing at least a document written in a markup language

(76) Inventor: Francois Ziserman, Guichen (FR)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/297,243

(22) PCT Filed: May 16, 2001
(86) PCT No.: PCT/FR01/01499

(30) Foreign Application Priority Data
May 31, 2000 (FR) 00/07074

(51) Int. Cl. G06F 15/00

(52) U.S. Cl. 715/513

(57) ABSTRACT

The invention concerns a module for generating objects, called Webbike module, for supplying at least one function for generating objects from raw data retrieved from at least a data source, containing at least a document expressed in a markup language. The invention is characterised in that: on reception by said object-generating module of a request for at least an object (3), said at least one object-creating function uses at least a retrieval subfunction, to inform the content of at least one member (31, 32, 33) concerning the structure of said at least one object (3).

The field of the invention is that of internet-type networks such as the global Internet network, for example. More precisely, the invention relates to a module for creating objects using raw data retrieved from one or a plurality of data sources containing documents elaborated using “mark-up” language. XML (“extended mark-up language”) files or web sites can represent such documents. Web site in this context is understood here and in the rest of this document to mean an Internet global network site or a site of any other internet type network.

For the sake of simplification, in the rest of this document a module is described for generating documents using data retrieved from web sites of the global Internet network. Of course, the invention relates also to the generation of objects using data retrieved from web sites of any other internet type network as well as to the creation of objects using data retrieved from any other data source of the type containing documents expressed using a mark-up language.

Today the global Internet network is seeing dizzying progress: the number of web sites is growing rapidly, whether public or private enterprises, organizations, associations or private individuals.

The Internet network has become one of the primary sources of information as the amount of data accessible from web sites has broadened in recent years. It has become imperative to know how to retrieve the information contained in the different web sites in order to make them available to users who, for example, do not have access to the global Internet network. Naturally, the invention can be applied to any other device, system, and/or procedure requiring the generation of objects using raw data retrieved from at least one web site or from at least one data source containing documents expressed in a mark-up language.

The first information retrieval modules using web sites came into being at multi-terminal publishing systems such as the Oracle “Portal-to-Go” system (registered trademark).

This type of system employs a data retrieval engine using web sites of the global Internet network. The retrieval engine performs a search of regular expressions using a recorded library; that is, it employs a pattern search in a given web page as a function of a predetermined grammar. For example, such a retrieval engine can isolate all of the words containing the letter “a” on an analyzed web page or even the patterns starting with an upper-case letter and ending with a period. The data retrieved are then expressed using an XML (“extended mark-up language”) type language.

A drawback of this prior-art technique is that such a retrieval engine does not allow set-up of a tree structure of the different objects retrieved from the web sites nor does it permit determining the logical links uniting the different information isolated by the retrieval engine.

Another drawback of this prior-art technique is that such a retrieval engine does not employ automatic tracking of any links between different web pages. Namely, if the retrieval engine identifies a URL (“uniform resource locator”) on a web page linking to another web page, it does not request access thereto to retrieve the data it contains.

Another drawback of this prior-art technique is that such a retrieval engine does not allow building of structured objects using information contained in one or a plurality of web sites. Namely, it is difficult to create an object comprised of a plurality of members, each one informed using information retrieved from a distinct web site.

Yet another drawback of this prior-art technique is that it does not observe the tree structure of the web page from which the constituent information of objects have been retrieved. In fact, such a search of regular expressions does not take into account the tree structure of the analyzed page. Thus, one could retrieve from the page a pattern belonging in part to a first branch and in part to a second branch of the tree structure of the page. Thus, after retrieval of the raw data contained in one web page, one loses all idea of navigation in the objects contained in the page analyzed.

Therefore, the object of the present invention is to eliminate these deficiencies of the prior art.

More precisely, one object of the invention is to provide a module allowing generation of objects using information accessible from one or a plurality of data sources containing documents expressed in a mark-up language. Namely, an object of the invention is to provide a module that makes possible generation of objects using data contained in an XML file or a web site, for example.

Another object of the invention is that of using a module for generating objects that is inexpensive to use.

A further object of the invention it to provide a module for generating objects that is simpler to use.

An object of the invention is also that of using a module for generating objects that are functional using any type of web site.

Another object of the invention is to provide a developing module for creation of objects that is capable of adapting to changes in the data source(s) (web site(s), XML files, etc.) using which it creates objects.

Yet another object of the invention is the use of a module for generating objects, in which the objects are generated independently of the presentation and/or the graphism of information within the source considered and depending solely on the raw data within said source.

An object of the invention is also that of providing a module for generating objects, in which the objects are generated independently of their utilization on exiting such a generating module and/or type of equipment to which they are transmitted after having been created.

And yet another object of the invention is to employ a module for generating objects, in which the objects are organized in a structured fashion.

The invention also has the object of providing a module for generating objects that adhere to or do not adhere to the tree structure of the web, from which the information constituting the objects created are retrieved.

These objects, as well as others that will become apparent in the following are achieved pursuant to the invention with the aid of an object generating module, called a Webbike module, providing at least one object generating function using raw data which are retrieved from at least one data source containing at least one document expressed using a mark-up language.

According to the invention, upon reception by said object generating module of a request for at least one object, said at least one object generating function utilizes at least one retrieval sub-function allowing to inform the content of at least one member relative to the structure of said at least one object.

Thus, the invention is based on an approach that is quite novel and inventive for the generation of objects using raw data retrieved from one or a plurality of data sources containing documents expressed in a mark-up language.

In fact, the invention is based namely on the use of a function for generating objects that permits on the one hand assembling structured objects and on the other hand retrieval of the information necessary to such assembling using one or a plurality of web sites or any other data source containing at least one document expressed in a mark-up language by utilizing a retrieval sub-function. In this fashion each of the constituent members of the object to be generated is informed using raw data retrieved from one or a plurality of web sites or from one or a plurality of XML folders, for instance, using the retrieval sub-function. The generation of structured objects makes possible, if desired, conservation of the tree-structure of the web site(s) (or the data source containing the documents expressed in the mark-up language) analyzed by the object generating module or definition according to a predefined criterion of a new tree, within which the generated objects can be organized.

According to an advantageous technique of the invention said at least one function for generating objects comprises in addition a comparison sub-function of said at least one object, on which said request falls with a list of objects previously at least partially generated in such a fashion as to utilize said at least one retrieval sub-function only for the generation of objects not previously generated and/or to complement any objects previously partially generated.

Thus, if an object has already been generated in response to a request previously addressed to and processed by the object generating module according to the invention, that object is sent directly to the equipment having sent such request without utilizing, once again, the object generating function. Likewise, if certain members of an object have been informed in the course of preceding requests, the retrieval sub-function only does searches for the data necessary to complete the members not previously informed within the data source(s) analyzed.

Advantageously, each retrieval sub-function is composed, according to a specific language, of at least one Webbike page comprising at least one Webbike tag and said at least one Webbike page is synchronized with at least one document expressed in a mark-up language of at least one data source; said at least one document comprising in its turn at least one mark-up language tag, said synchronization permitting a Webbike tag to position itself over a mark-up language tag in order to retrieve the raw data for the purpose of generating objects.

Thus, the invention is based on the novel and inventive concept of synchronization on the tags contained in a document expressed in a mark-up language in order to retrieve the raw data necessary for generating objects.

In the rest of this document such second specific language is called Webbike language: the Webbike language makes possible generation of objects (for example using an SIDL (“service interface definition language”)) and initializing the value of their attributes using information contained in a data source in a mark-up language. Thus, the Webbike language allows description of a path within a web site on the basis of the presence of HTML tags and on the links existing between the different HTML pages. The Webbike language having a structure relatively close to the structure of a mark-up language, certain Webbike tags are similar to HTML or XML tags of the same name, and namely those tags of the types “frame”, “form”, or select, for example. The Webbike language allows description of a complete service. Consequently, a given Webbike page can contain the description of a plurality of associated HTML pages regardless of the address of the server providing them or of a plurality of XML documents.

The principle of a language such as Webbike is that of indicating to the module for generating objects how to search for the information in the HTML pages or in the XML documents, for example. In this scheme, the many Webbike tags make it possible to synchronize with the source of the mark-up language in question. Synchronization allows the Webbike module to position itself over a mark-up language tag and retrieve information such as the value of its attributes, for example, in order to apply them to the members of SIDL objects.

Advantageously, each object comprises at least one member relative to the structure of said object and at least one assembler, said assembler permitting said module for generating objects to inform the contents of said at least one member.

Thus, for instance, one can imagine that an object “film” is comprised of three members: namely a first member “title of the film”, a second member “summary of the film”, and a third member “director”. When it receives a request for generating objects, the module according to the invention assembles a structured object by filling in the contents of each of these different component members of the object.

Advantageously, on receiving a request relative to at least one first object said retrieval sub-function further allows filling in the content of at least one member of at least one second object, which is distinct from said at least one first object, when the raw data allowing filling in of said content are present within said document with which the at least one Webbike page is synchronized.

Thus, when the module for generating objects according to the invention accesses, for instance, a web page, it generates at least partially all of the objects that can be created using the information contained in that web page. The retrieval sub-function then retrieves all of the raw data allowing the contents of the members of the objects to be informed, including the objects to which the processed request does not apply.

In this fashion the module for creating objects according to the invention optimizes access to the data sources by going through and analyzing one time only each of the web pages or XML documents contained in the data sources. By way of example, the module for creating objects accesses a given web page in order to create an object, “film”: it then also retrieves the raw data contained in the page and allows filling in of at least certain of the members of the objects “director” and “film festival.”

According to one feature of the invention there is at least the three following types of Webbike tags:

Webbike synchronization tags allowing searching for a tag in mark-up language or for a “frame” of a mark-up language tag in said at least one document expressed in mark-up language in order to position itself over said mark-up language tag or over said “frame”;

Webbike structure tags allowing definition of at least one execution condition of said Webbike synchronization tags;

Webbike command tags allowing using at least one predetermined operation after having been positioned over said mark-up language tag or over said “frame”.

The set of Webbike tags comprise a Webbike instruction tree controlling an interpreter in order to allow “navigation” within the data source analyzed. Such navigation is triggered by the receipt of a request for generating objects by the module for generating objects according to the invention.

There is, according to the invention, a number of synchronization type tags allowing synchronization over a mark-up language tag of the page or document analyzed by the module for creating objects. By way of example, one might cite a Webbike tag of the type permitting synchronization on the next HTML comment or a Webbike tag of the type allowing setting of conditions for synchronization on the content of a mark-up language tag. This synchronization condition can consist in carrying out a search of regular expressions in the content of said mark-up language node. It must be noted that such a regular expression search is also used within a web page in the Portal-to-Go multi-terminal publishing system but for an entirely different purpose (direct pattern search in a page, without regard to the tree-structure of the page and not for synchronization on the HTML tags of the page for the purpose of retrieving the raw data contained in each of the tags).

According to a further advantageous feature of the invention, there is additionally at least one of the following types of Webbike tags:

Webbike tags of the type allowing definition of a retrieval sub-function; (Webbike tag)

Webbike tags of the type allowing indication of the object(s) used in a retrieval sub-function; (tool tag)

Webbike tags of the type allowing definition of a Webbike page; (page tag)

Webbike tags of the type that can be re-used with a list of parameters, if applicable; (method tag)

Webbike tags of the type allowing declaration of the parameters of a page or of a re-usable tag; (param-list tag)

Webbike tags of the type allowing calling another Webbike page without synchronizing on a mark-up language tag; (link tag)

Webbike tags of the type allowing calling a re-usable type tag; (call tag)

Webbike tags of the type allowing creation of a link to another Webbike tag; (action tag)

Webbike tags of the type allowing definition of a dynamic URL (“uniform resource locator”) for an HTML page; (dynamic-URL tag)

Webbike tags of the type allowing assignment of a value to a parameter; (param tag)

Webbike tags of the type allowing repetition of a sequence of at least one Webbike tag; (multiple tag)

Webbike tags of the type allowing at least one command to be inserted into a place normally not authorized for a sequence of at least one Webbike tag; (block tag)

Webbike tags of the type allowing defining at least two ways of synchronization according to the content of a document; (switch tag)

Webbike tags of the type allowing conditional interpretation of a sequence of at least one Webbike tag. (if/else tag)

Several examples of the syntax associated with certain of the aforementioned Webbike tags are provided in the appendix.

Advantageously, said Webbike command tags belong to the group formed by:

Webbike tags allowing definition of a block of at least one command associated with a tag (Webbike tag) of the type allowing definition of a retrieval sub-function; (command tag)

Webbike tags of the type allowing retrieval of the text content of a mark-up language tag; (body tag)

Webbike tags of the type allowing retrieval of at least one attribute of the current mark-up language tag; (attributes tag)

Webbike tags of the type allowing designation of a constant value; (constant tag)

Webbike tags of the type assuring functions for transformation of information retrieved from a file expressed in a mark-up language (function—substring, function—wordextract, function—check-URL, function—java).

Advantageously said at least one command, from a block defined by a Webbike tag, belongs to the group comprising:

the object generating commands;

the commands for changing at least one member of an object.

There is also a command for generating a new SIDL object, a command allowing updating of the members of an SIDL object, and a command allowing addition of text to an member of an SIDL object.

According to one advantageous technique according to the invention, there is at least the two following types of Webbike page:

static Webbike pages, analyzed on launching said retrieval sub-function;

dynamic Webbike pages, accessible from another Webbike page by a special type of Webbike tag called a Webbike link.

Thus, the static pages have a fixed URL that is specified in a given Webbike tag called a “page” tag and these are analyzed upon launching of the application. Generally at least one static page is required in a service. The dynamic pages are obtained using a Webbike link. A dynamic page can define the parameters allowing transfer of objects from page to page. A parameter can be a simple object such as a string of characters or an SIDL object.

According to one advantageous embodiment of the invention there is at least one specific Webbike synchronization type tag allowing searching for a predetermined mark-up language tag in order to position itself on said predetermined mark-up language tag and, in addition, a generic Webbike synchronization tag allowing searching for a non-predetermined mark-up language tag but which has been specified in parameters, in order to position itself on said non-predetermined mark-up language tag.

In fact, the mark-up languages such as XML, WML or HTML are too rich to be able to provide a Webbike synchronization tag for each existing mark-up language tag. In order not to unnecessarily overload the Webbike language, there is, according to the invention, a generic Webbike synchronization type tag that allows synchronization on any tag of a mark-up language once the name of the member is stated on which one wants to synchronize.

Advantageously, at least certain synchronization tags take into account the conditions of retrieval bearing on the attribute and/or on a textual content and/or on at least one child tag of a mark-up language tag found.

If a plurality of overlapping tags respond to the criteria set in the retrieval conditions, the first tag encountered is generally kept.

Advantageously, said Webbike module utilizes a function for managing cookies.

Thus, the cookies sent by an HTTP server at the time of loading an HTML page are stored in a module for generating objects according to the invention. They are automatically sent by such a Webbike module when the pages are accessed that correspond to the domain of the cookie. Certain web sites depend on administration of cookies and it is important to identify the resource that invokes transmission of the cookie in order to access it using the Webbike module at the opportune moment.

According to an advantageous technique said specific language is assembled with the aid of an XML type language.

In effect, the XML language (“extended mark-up language”) that is a language retrieved from the SGML (“standard generalized mark-up language”) is a generic language that is particularly adapted to the publication and exchange of data.

Preferably, such a module for generating objects according to the invention is used in a multi-terminal publishing system of the type offering access to at least one application relating to a service and providing for a plurality of terminals, using at least two types of distinct terminals, with the information contained in at least one information source, said system comprising:

at least said module for generating objects;

a module for generating a response in the format of a general presentation, in response to a request formulated by a terminal and relative to a given application, said application being defined in said module for generating a response by a plurality of contexts and a navigation policy between said contexts, each context comprising at least one action and/or at least one object generated by said at least one module for generating objects, said response resulting from navigation using said navigation policy within said plurality of contexts;

a presentation module allowing transformation of said response in a generic presentation format into a response in a format specific to the type of said terminal having formulated said request.

In fact, the accessibility of terminals of various types to services and to information available on the global Internet network or more generally to any data source containing at least one document expressed in a mark-up language is an endlessly growing priority for telecommunications operators.

Now, publication of the same information to different types of terminals is made difficult by the diversity of computer languages and communications protocols used on each type of terminal. Thus, for instance, the WAP (“wireless application protocol”) type mobile telephones use the WML (“wireless mark-up language”) language while the terminals such as those used for personal computers use an HTML language.

Such a module for generating objects according to the invention is thus particularly suitable for the realization of a multi-terminal publishing system allowing information to be published that are available in one or a plurality of data sources containing documents expressed in a mark-up language (for example web sites containing one or a plurality of web pages) to the different types of consultation terminals such as WAP type mobile telephones, PDA type terminals (“personal digital assistant”), Minitel type terminals, etc.

It is also conceivable that such a module for generation of objects according to the invention be used in a multi-terminal publishing system comprising likewise other modules for generation of objects of the type allowing, for instance, generating of objects using raw data contained in a database or in a java module.

Such a module for generating objects according to the invention is thus used in a multi-terminal publishing system based on the concepts on the one hand of separation of the information and presentation of the information and on the other hand of navigation, allowing the construction of a tree-structure of objects.

Preferably said multi-terminal publishing system further comprises an interface module enabling intercepting and analysing said requests generated by a terminal so as to:

identify the type of said terminal;

create a new request in generic request format intended for said response generating module.

Thus the type of look-up terminal being identified, the multi-terminal publishing system implementing the module for generating objects according to the invention can send a response whose content and presentation are perfectly matched to the terminal that transmitted the request.

Other features and advantages of the invention will become more clearly apparent on reading the following description of a preferred embodiment provided as a non-limiting example, and the annexed drawings, wherein:

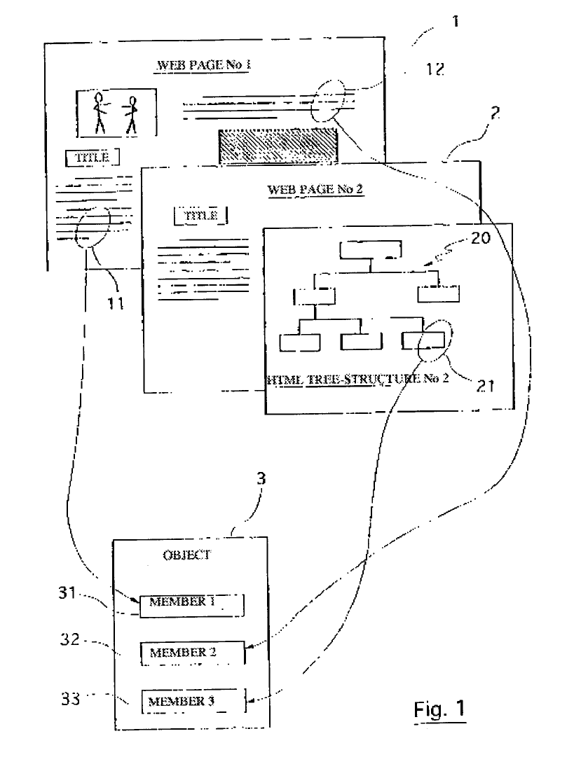

FIG. 1 represents a synopsis of an exemplary embodiment of an object-generating operation done by the module for generating objects according to the invention;

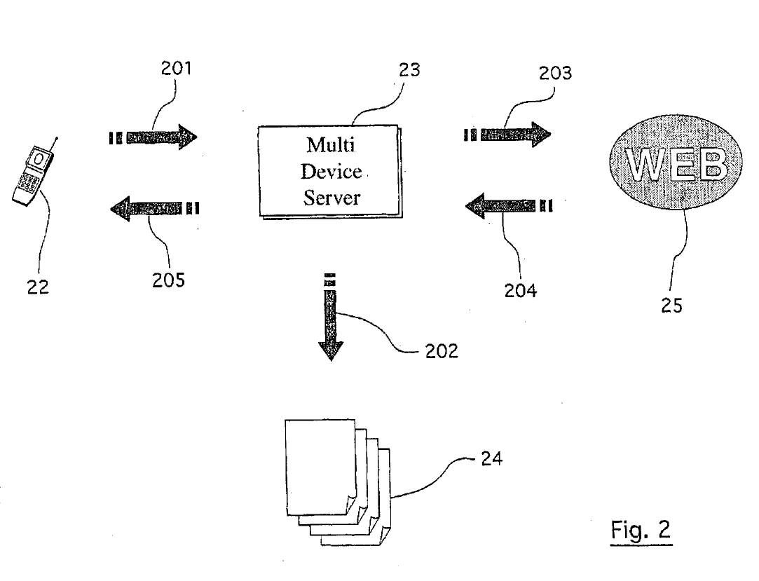

FIG. 2 represents the implementation of an object-generating operation represented in FIG. 1 in a multi-terminal publishing system comprising a module for generating objects according to the invention.

The overall concept of the invention is based on the synchronisation on the tags contained in a document expressed in a mark-up language in order to retrieve from it the raw data necessary for assembly of objects.

FIG. 1 represents an embodiment of an object generator using raw data retrieved from one or a plurality of web sites.

The invention naturally applies also to generating of objects using any other data source containing at least one document expressed in a mark-up language.

Generation of an object 3 is conceivable using raw data retrieved from a first HTML page 1 of a first web site and a second HTML page 2 from a second web site which can be identical or not to the first site with which page 1 is attached. Such an object 3 is, for example, comprised of three members marked 31, 32, and 33.

The module for generating objects according to the invention (not shown in FIG. 1) employs a comparison sub-function for the purpose of checking that the object 3 has not previously been created in whole or in part in the course of processing a previous request for generating objects.

If the object 3 does not yet exist, the module for creation of objects according to the invention employs a retrieval sub-function in order to inform the contents of the members marked 31, 32, and 33 of the object 3.

The module for generating objects is thus connected to the first web site and requests access to the HTML pages marked 1. The HTML page marked 1 is thus scanned by the interpreter with the aid of the Webbike language. When the Webbike tags are carrying commands they are then executed.

After analysis of the HTML page marked 1, the module for generating objects according to the invention carries out a synchronization on the HTML tags contained in the page 1 in order to retrieve the information they contain. Thus, the HTML tag associated with the zone marked 11 of the HTML page marked 1 contains raw data allowing the contents of the member marked 31 of the object 3 to be informed. The retrieval sub-function of the module for generating objects according to the invention thus retrieves the information contained in the zone marked 11 of the page 1 and utilizes it to inform the contents of the member marked 31.

The module for generating objects according to the invention likewise determines, by synchronization on the HTML tag associated with the zone marked 12 of the HTML page marked 1, that the raw data contained in such HTML tag allow filling in of the contents of the member marked 32 of the object 3. The retrieval sub-function then retrieves the data contained in the HTML tag associated with the zone marked 12 in such a fashion as to complete the member referenced 32 of the object 3.

After complete analysis of the HTML page marked 1, only the members marked 31 and 32 of the object 3 have been able to be completed. The module for generating objects then undertakes a synchronization on the HTML tags of a page marked 2 in order to retrieve the raw data allowing the contents of the member marked 33 to be informed. It is conceivable, for example, that the module for generating objects according to the invention accesses the HTML page marked 2 by the intermediary of a link inserted into the HTML page marked 1.

The tree 20 corresponds to a schematic representation of the tree structure of the HTML page marked 2. Each of the tags of the tree 20 represents one HTML tag on which a Webbike tag can be synchronized.

Thus, synchronization on the HTML tags of the page marked 2 makes it possible to identify that the raw data contained in the HTML tag marked 21 allow the contents of the member marked 33 of the object 3 to be willed in. The module for generating objects according to the invention then utilizes a retrieval sub-function that retrieves the raw data contained in the HTML tag marked 21 and fills in the member marked 33 of the object 3.

In the following, referring to FIG. 2, the generation of objects by a generating module according to the invention is described in a multi-terminal publishing system.

A communications terminal 22 issues a request marked 201 to the address of the multi-terminal publishing system 23 shown in FIG. 2. Such a terminal 22 can be a WAP type terminal, a PDA type terminal, a Minitel type terminal, a personal computer or any other type of terminal that is capable of issuing a request to the address of such a multi-terminal system 23.

The request marked 201 is, for instance, a request for access to a pre-determined page on a given web site 25.

The multi-terminal publishing system 23 analyzes the request 201 in the course of a step marked 202. Namely, the multi-terminal publishing system 23 studies the description of the service that the terminal 22 wishes to access by using an XML type language.

In the course of a step marked 203, the multi-terminal publishing system 23 issues a request to the address of the module for generating objects according to the invention (not shown in FIG. 2). This request makes it possible to indicate to the module for generating objects according to the invention the objects necessary to the elaboration of a response to the address of the terminal 22 and any constructors to be used for filling in the content of the member(s) of the objects to be generated.

The module for generating objects according to the invention then carries out an object generation of the type represented in FIG. 1 using the web page that the terminal 22 wishes to consult. For this purpose it effects a synchronization on the HTML tags associated with this web page and retrieves the raw data contained in such HTML tags. It then constructs a set of objects corresponding to the information accessible from such web page and which are preferably expressed using a SIDL type (“service interface definition language”) language.

In the course of a step marked 204, the module for generating objects according to the invention transmits the objects generated to the multi-terminal publishing system 23. The multi-terminal publishing system 23 then generates a response in a generic format by using a navigation within the contexts associated with the generated objects. Such a response in the generic format is, for instance, an XML type tree. The multi-terminal publishing system 23 then effects, by means of a presentation module (not shown in FIG. 2) a transformation of the response in the generic format into a response in a format specific to terminal 22 type having sent the request by means, for instance, of characteristic style sheets for each type of consultation terminal capable of accessing the multi-terminal publishing system 23.

In the course of a step marked 205, the multi-terminal publishing system 23 transmits to the terminal 22 a response corresponding to the web page to which the terminal 22 desires access and whose content and presentation are adapted to the terminal 22 type.

[image]

[image]

1. A module for generating objects, called a Webbike module, for providing at least one function for generating objects using raw data retrieved from at least one data source (25) containing at least one document expressed in a mark-up language,
characterized in that on reception by said module for generating objects of a request (201) for at least one object, said at least one object-creating function uses at least one retrieval sub-function allowing to fill in the contents of at least one member (31, 32, 33) concerning the structure of said at least one object (3),
each retrieval sub-function being composed, in a specific language, of at least one Webbike page comprising at least one Webbike tag
and in that said at least one Webbike page is synchronized with at least one document (1, 2) expressed in a mark-up language of at least one data source, said at least one document itself comprising at least one mark-up language tag, said synchronization allowing a Webbike tag to position itself on a mark-up language tag (21) in order to retrieve the raw data for the purpose of creation of objects.

2. A module for generating objects according to claim 1, wherein said at least one object-generating function comprises, in addition, a comparison sub-function of said at least one object to which said request refers with a list of objects previously generated at least in part in such a fashion that said at least one retrieval sub-function is utilized only for the generation of objects that have not already been generated and/or in order to complement those objects previously partially generated.

3. A module for generating objects according to any one of claims 1 and 2, wherein each object comprises at least one member concerning the structure of said object and at least one constructor, said at least one constructor allowing said module for generating objects to inform the content of said at least one member.

4. A module for generating objects according to claim 3, wherein on receiving a request concerning at least a first object, said retrieval sub-function further allows informing the content of at least one member of at least one second object that is distinct from said at least one first object, when the raw data allowing informing of said content are present in said document with which said at least one Webbike page has been synchronized.

5. A module for generating objects according to any one of claims 1 to 4, wherein there is at least the following three types of Webbike tags:
Webbike synchronization tags allowing searching for a mark-up language tag or a frame of a mark-up language tag in said at least one document expressed in a mark-up language in order to position itself over said mark-up language tag or over said frame;
Webbike structure tags allowing defining of at least one execution condition of said Webbike synchronization tags;
Webbike command tags allowing utilization of at least one predetermined operation after being positioned over said mark-up language tag or over said frame.

6. A module for generating objects according to claim 5, wherein there is, in addition, at least one of the following Webbike tags:
Webbike tags of the type allowing definition of a retrieval sub-function;
Webbike tags of the type allowing indication of object(s) used in a retrieval sub-function;
Webbike tags of the type allowing the defining of a Webbike page;
Webbike tags of the type that can be re-used with a parameters list, if applicable;
Webbike tags of the type allowing declaration of the parameters of a reusable page or tag;
Webbike tags of the type allowing calling another Webbike page without being synchronized on a tag of a mark-up language;
Webbike tags of the type allowing calling a re-usable type tag;
Webbike tags of the type allowing creation of a link to another Webbike page;
Webbike tags of the type allowing definition of a dynamic URL for a HTML page;
Webbike tags of the type permitting assigning a value to a parameter;
Webbike tags of the type allowing repeating a sequence of at least one Webbike tag;
Webbike tags of the type allowing insertion of at least one command in a place normally not authorized for a sequence of at least one Webbike tag;
Webbike tags of the type allowing defining of at least two ways of synchronization according to the content of the document;
Webbike tags of the type allowing interpreting in conditional fashion of a sequence of at least one Webbike tag.

7. A module for generating objects according to any one of claims 5 and 6, wherein said Webbike command tags belong to the group comprising:
Webbike tags of the type allowing defining of a retrieval sub-function;
Webbike tags of the type allowing retrieval of text content from a mark-up language tag;
Webbike tags of the type allowing retrieval of at least one attribute of the current mark-up language tag;
Webbike tags of the type allowing to designate a constant value;
Webbike tags of the type allowing assuring of the functions of transformation of information retrieved from a mark-up language file.

8. A module for generation of objects according to claim 7, wherein said at least one command of a block defined by the Webbike tag, belongs to the group comprising:
the object generating commands;
the change commands of at least one member of an object.

9. A module for generating objects according to any one of claims 1 to 8, wherein there is at least the following two types of Webbike pages:
static Webbike pages analyzed upon launching of said retrieval sub-function;
dynamic Webbike pages accessible using another Webbike page via a special type of Webbike tag, called a Webbike link.

10. A module for generating objects according to any one of claims 5 to 9, wherein there is at least one specific Webbike synchronization tag allowing searching of a pre-determined mark-up language tag in order to position itself on said pre-determined mark-up language tag and, in addition, a generic Webbike synchronization tag allowing searching a non-predetermined mark-up language tag but specified in parameters for the purpose of positioning itself on said non-predetermined mark-up language tag.

11. A module for generating object according to any one of claims 5 to 10, wherein at least certain of the Webbike synchronization tags take into account retrieval conditions referring to the attributes and/or to a text content and/or to at least one child tag of a mark-up language tag found.

12. A module for generating objects according to any one of claims 1 to 11, wherein said Webbike module uses a cookies administration function.

13. A module for generating objects according to any one of claims 1 to 12, wherein said specific language is constructed with the aid of an XML language.

14. A module for generating objects according to any one of claims 1 to 13, wherein said mark-up language belongs to the group comprising:
the XML type languages (“extended mark-up language”);
the HTML type languages (“hypertext mark-up languages);
the SGML type languages (“standard generalized mark-up language”) and its derivatives;
the WML type languages (“wireless mark-up language”).

15. A module for generating objects according to any one of claims 1 to 14, wherein it is used in a multi-terminal publishing system (23) of the type offering access to at least one application corresponding to a service, allowing providing to a plurality of terminals (22), using at least two distinct terminal types, of information contained in at least one information source, said system comprising:
at least said module for generating objects;
a module for generating a response in a generic presentation format in response to a request formulated by a terminal and concerning a given application, said application being defined in said response-generating module by a plurality of contexts and a navigation policy among said contexts, each context comprising at least one action and/or at least one object created by said at least one module for generating objects, said response resulting from a navigation according to said navigation policy within said plurality of contexts;
a presentation module allowing transforming of said response in generic presentation format into a response in a presentation format specific to the type of said terminal having formulated said request.

16. A module for generating objects according to claim 15, wherein said multi-terminal publication system comprises, in addition, an interfacing module allowing intercepting and analyzing of said request formulated by a terminal so as to:
identify the type of said terminal;
generate a new request in the generic request format intended for said response-generating module.
